(19) United States
(12) Patent Application Publication
(10) Pub. No.: US 2026/0211400 A1
(43) Pub. Date: Jul. 23, 2026

(54) AUTOMATED TRACKING SYSTEM AND METHOD FOR A PLANT FOR PACKAGING POURABLE PRODUCTS

(71) Applicant: SIDEL PARTICIPATIONS, Octeville-sur-Mer (FR)

(72) Inventors: Rossana BORGESE, Parma (IT); Mattia CENCI, Parma (IT)

(21) Appl. No.: 19/138,387

(22) PCT Filed: Dec. 13, 2022
(86) PCT No.: PCT/EP2022/085501

§ 371 Date: Jun. 12, 2025

(51) Int. Cl. G05B 19/418

(52) U.S. Cl. CPC G05B 19/4183; G05B 19/41865; G05B 2219/32025; G05B 2219/45048

(57) ABSTRACT

Provided is an automated tracking system in a packaging plant for packaging a pourable product, the automated tracking system having a first marking unit to mark each primary packaging unit in the primary packaging machine with a respective primary marking; a second marking unit to mark each secondary packaging unit in the secondary packaging machine with a respective secondary marking; a first imaging module, to image the first conveying unit; and a control unit having: an acquisition module to acquire a first set of information at least from the first marking unit, said first imaging module, and the second marking unit; and a prediction module to process the acquired first set of information in order to track the primary packaging units in the path between the primary and secondary packaging machines.

### TECHNICAL FIELD

The present invention relates to an automated tracking system and method for a plant for packaging pourable products.

### BACKGROUND ART

As it is known, a packaging plant comprises a number of processing machines arranged to form a packaging line, which may include for example:
a forming machine, for example a blower, configured to form containers from so-called preforms, e.g., by blowing;
a filling machine, configured to fill the containers with a desired pourable product, for example a food beverage;
a capping machine, configured to close the filled containers with caps; and
a labelling machine, configured to attach labels to the filled containers.

The forming, filling, capping and labelling machines may be grouped in a single combined, or “combi”, processing machine, denoted in the following as primary packaging machine, configured to produce sequentially a plurality of “primary packaging units” (i.e., formed, filled, capped and labelled containers).

The packaging plant may moreover comprise a secondary packaging machine (e.g., a packing or wrap-around machine), configured to arrange the primary packaging units in packs, cases, wraps, trays, or similar, denoted in the following as “secondary packaging units”.

The same packaging plant may possibly further comprise a tertiary packaging machine (e.g., a palletizing machine), at the end of the container processing line, for forming ordered groups of the secondary packaging units, denoted in the following as “tertiary packaging units”, e.g., pallets.

The packaging plant may also include further processing machines, such as a product preparation machine, a sterilising machine, a pasteurization machine or a container washing machine.

The packaging plant generally includes a number of conveying lines (conveyors or buffers), of the passive or accumulator type, configured to convey elements being processed, such as the primary, secondary and tertiary packaging units, across the container packaging line.

A need that is surely felt in such packaging plants is that of tracking the packaging units along the packaging line.

This is of particular importance for example when tests performed on containers sampled from the processing line during production show contaminations (or lack of sterility) occurring in one or more of the sampled containers.

In this case, for example, knowledge of the location, in the secondary and/or tertiary packaging units, of the containers (primary packaging units) produced immediately before or after the sampled containers allows to isolate the same packaging units from the rest of the production (e.g., for disposal thereof or further analysis).

Known solutions for implementing tracking of the packaging units envisage use of a plurality of markers and electronic readers arranged along the packaging line, at a plurality of monitoring sites distributed along the same packaging line.

This solution is, however, quite expensive, due to the number of markers and electronic readers that are required in order to achieve a sufficiently accurate tracking. Moreover, errors may occur in the identification of the packaging units by the same readers, which may jeopardize the tracking operations

The present Applicant has realized that implementation of tracking operations may therefore be not fully satisfactory in current packaging plants.

### DISCLOSURE OF INVENTION

The aim of the present invention is to provide a solution that will enable the problems highlighted previously to be solved.

According to the present invention an automated tracking system and method are provided, as defined in the appended claims.

### BRIEF DESCRIPTION OF THE DRAWINGS

For a better understanding of the present invention, preferred embodiments thereof are now described, purely by way of non-limiting example, with reference to the attached drawings, wherein:

FIG. 1 is a general diagram of a packaging plant;

FIG. 2 is a schematic representation of an automated tracking system in the packaging plant, according to an embodiment of the present solution; and

FIG. 3 is a schematic and exemplary flowchart of operations performed by a control unit in the tracking system of FIG. 2.

### BEST MODE FOR CARRYING OUT THE INVENTION

As will be discussed in detail in the following, the present solution relates to an automated, machine-implemented, tracking system and method for a packaging plant, providing a reliable estimation of the location of the formed primary packaging units (containers) in the secondary and possibly tertiary packaging units at the end of the packaging line.

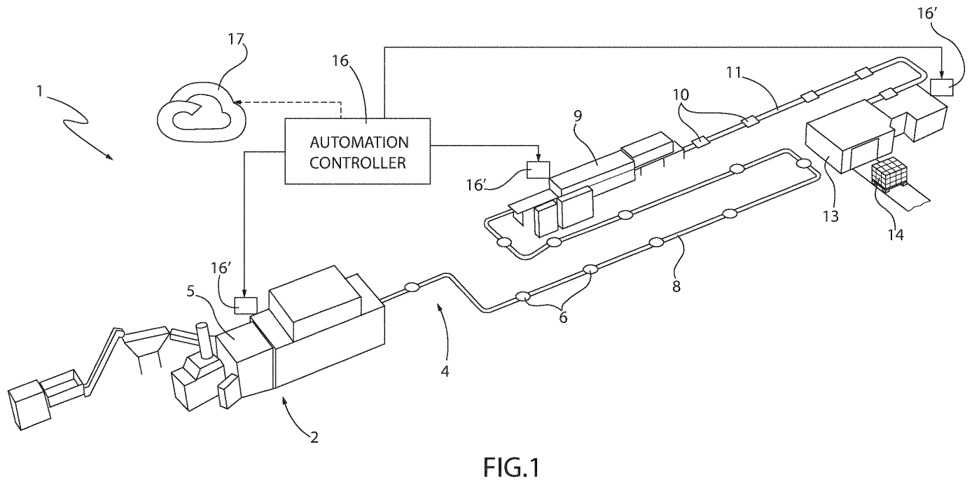

FIG. 1 shows an exemplary packaging plant, generally denoted with 1, including a number of processing machines 2 arranged along a packaging line 4.

In the example, the packaging plant 1 comprises, from inlet to outlet of the packaging line 4:
a primary packaging machine 5, receiving container preforms and configured to perform combined operations, e.g., forming, filling, capping and labelling operations, to provide at output primary packaging units 6 (filled, labelled and closed containers), shown schematically;
a first conveyor (or buffer) 8, transporting the primary packaging units 6 received from the primary packaging machine 5;
a secondary packaging machine 9, receiving the primary packaging units 6 from the first conveyor 8 and configured to produce sequentially a plurality of secondary packaging units 10 (e.g., packs, cases, wraps, trays), each secondary packaging unit 10 including a group of at least two orderly arranged primary packaging units 6;
a second conveyor 11, configured to transport the secondary packaging units 10 received from the secondary packaging machine 9; and
a tertiary packaging machine 13, configured to produce sequentially a plurality of tertiary packaging units 14 (e.g., pallets ready for stocking and transport), each tertiary packaging unit 14 including a group of at least two orderly arranged secondary packaging units 10.

The packaging plant 1 also comprises an automation controller 16, which is coupled to respective control units 16′ of the processing machines 2; in a known manner, the automation controller 16 is configured to supervise general operation of the processing machines 2 and receives information about the operative status of the same processing machines 2 from the respective control units 16′.

As shown schematically, the automation controller 16 may be coupled to a remote cloud platform 17.

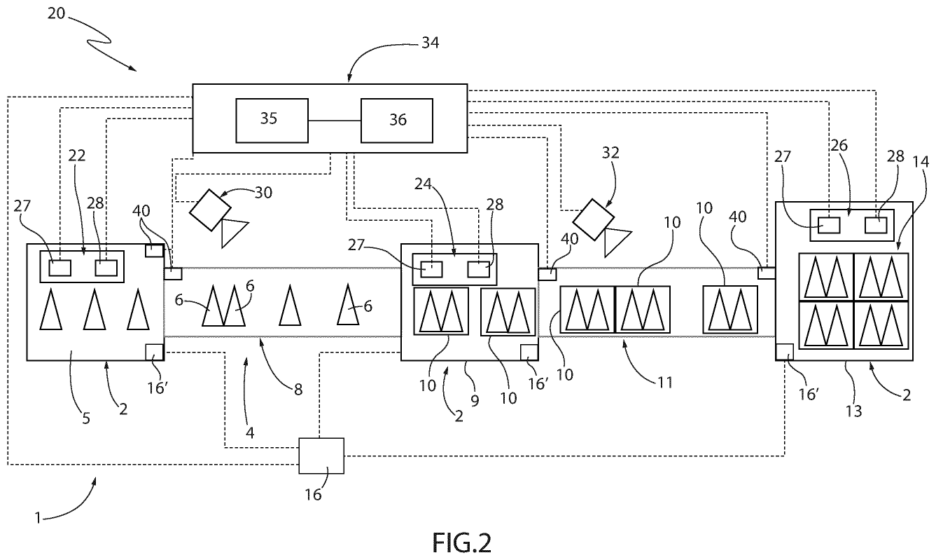

With reference also to FIG. 2, an automated tracking system, denoted in general with 20, for the packaging plant 1 is now described.

The automated tracking system 20 comprises:
a first marking unit 22, configured to mark the primary packaging units 6 sequentially formed in the primary packaging machine 5, with a respective primary marking (including any suitable code for univocal identification of the same primary packaging units 6);
a second marking unit 24, configured to mark the secondary packaging units 10 formed in the secondary packaging machine 9 with a respective secondary marking (again, including any suitable code for univocal identification of the secondary packaging units 10); and
a third marking unit 26, configured to mark the tertiary packaging units 14 in the tertiary packaging machine 13 with a respective tertiary marking (again, including any suitable code for univocal identification of the same tertiary packaging units 14).

The first, second and third marking units 22, 24, 26 may be arranged at the primary, respectively, secondary or tertiary packaging machines 5, 9, 13 in any position suitable to cooperate with the primary, respectively secondary or tertiary, packaging units 6, 10, 14 being formed therein (preferably at the outlet of the same machines).

In a possible embodiment, each of the first, second and third marking units 22, 24, 26 may comprise a respective marker 27, configured to assign an univocal identification code (e.g., a data matrix, a QR Code, a Barcode) to the primary, respectively secondary or tertiary, packaging units 6, 10, 14; and a reader 28, configured to read and possibly store in a non-volatile memory the assigned univocal identification codes (for example in association with a time of reading, e.g., referred to a master clock of the packaging plant 1).

The automated tracking system 20 further comprises:
a first imaging module 30, e.g., a camera or generally an image sensor, configured to image the first conveyor 8, in order to monitor the flow of the primary packaging units 6 received from the primary packaging machine 5 and conveyed towards the second packaging machine 9; and
a second imaging module 32, e.g., a camera or generally an image sensor, configured to image the second conveyor 11, in order to monitor the flow of the secondary packaging units 10 received from the secondary packaging machine 9 and conveyed towards the tertiary packaging machine 13.

Both the first and second imaging modules 30, 32 may be configured to acquire images and/or videos of the first, respectively, second conveyors 8, 11, with reference to the flow of the primary, respectively, secondary packaging units 6, 10.

The first and second imaging modules 30, 32 may be arranged at the first and, respectively, second conveyors 8, 11, in any location suitable for monitoring the primary, respectively secondary packaging units 6, 10.

The automated tracking system 20 moreover comprises a control unit 34, comprising:
an acquisition module 35 configured to acquire a first set of information at least from the first marking unit 22, the second marking unit 24 and the first imaging module 30, the first set of information including marking information received from the first and second marking units 22, 24 and monitoring information received from the first imaging module 30; and
a prediction module 36 configured to process the acquired first set of information in order to track the primary packaging units 6 in the path between the primary and secondary packaging machines 5, 9, in particular in order to estimate, for each primary packaging unit 6, the marking of a specific secondary packaging unit 10 in which the same primary packaging unit 6 is packaged, based on a statistical prediction model applied on the acquired first set of information.

In particular, the acquisition module 35 is coupled in any suitable manner (wired or wirelessly) to the first marking unit 22, the second marking unit 24 and the first imaging module 30.

The control unit 34 may be implemented by any suitable computing or processing unit, executing a set of software instructions; in a possible embodiment, the control unit 34 is located at the packaging plant 1 (alternatively, the same control unit 34 may be implemented remotely with respect to the same packaging plant 1, e.g. in the remote cloud processing platform 17).

The same control unit 34 is operatively coupled (e.g., via any suitable wired or wireless communication link) to the automation controller 16 of the packaging plant 1, which is coupled to the respective control units 16′of the processing machines 2. As an alternative (here not shown), the control unit 34 may be operatively coupled directly to the respective controllers 16′of the processing machines 2, so as to possibly receive information about their operative status.

According to a further aspect of the present solution:
the acquisition module 35 of the control unit 34 is further configured to acquire a second set of information at least from the second marking unit 24, the third marking unit 26 and the second imaging module 32, the second set of information thus including marking information received from the second and third marking units 24, 26 and monitoring information received from the second imaging module 32; and
the prediction module 36 is further configured to process the acquired second set of information in order to track the secondary packaging units 10 in the path between the secondary and tertiary packaging machines 9, 13 in particular in order to estimate, for each secondary packaging unit 10, the marking of a specific tertiary packaging unit 14 in which the same secondary packaging unit 10 is packaged, based on a statistical prediction model applied on the acquired second set of information.

The above-discussed statistical prediction model, which is implemented in the prediction module 36 of the control unit 34, may include any known statistical approach, e.g. based on a Discrete Element Method (DEM), which, as it is known, is a numerical method (widely applied, e. g., in computational fluid dynamics analysis) for describing the motion and behavior of particular systems as the sum of individual contact events within the same systems.

The prediction model can be based in addition or in alternative on a Montecarlo simulation method.

According to a further aspect of the present solution, the automated tracking system 20 also comprises a number of monitoring sensors 40, arranged along the packaging line 4 and configured to provide operating data related to the packaging operations performed by the processing machines 2.

The acquisition module 35 of the control unit 34 may be configured to acquire the operating data provided by the monitoring sensors 40; and the prediction module 36 may be further configured to process the acquired operating data to perform the above discussed estimation of the position of the primary and/or secondary packing units 6, 10.

In particular, the operating data may be processed to improve the accuracy of the estimation, for each primary packaging unit 6, of the marking of the specific secondary packaging unit 10 in which the same primary packaging unit 6 is packaged, based on the statistical prediction model applied on the acquired first set of information and, in this case, the operating data; and, for each secondary packaging unit 10, of the marking of the specific tertiary packaging unit 14 in which the same secondary packaging unit 10 is packaged, based on a statistical prediction model applied on the acquired second set of information and, in this case, the same operating data.

The monitoring sensors 40 may be arranged at one or more of the processing machines 2 of the packaging line 4 and at one or more of the first and second conveyors 8, 11.

The same monitoring sensors 40 may include for example: speed sensors, configured to provide data related to the speed of the first and/or second conveyors 8, 11 or, in general, of moving parts of the processing machines 2 of the packaging line 4; position sensors, configured to provide data related to the position of electric motors (driving the above first and/or second conveyors 8, 11) or in general of parts of the processing machines 2; presence and/or motion detectors; and in general, any other sensor, designed to provide operating data directly or indirectly related to tracking of the packaging movement along the packaging line 4.

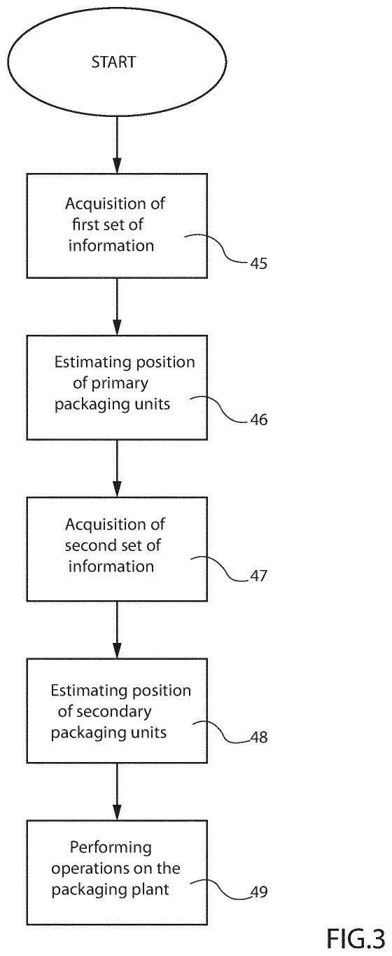

With reference to FIG. 3, general operation of the automated tracking system 20 thus envisages the following operations, not necessarily in the order presented hereinbelow:
acquisition, by the acquisition module 35 of the control unit 34, of the first set of information at least from the first marking unit 22, the second marking unit 24 and the first imaging module 30, as shown at step 45;
estimation, for each primary packaging unit 6, of the marking of the specific secondary packaging unit 10 in which the same primary packaging unit 6 is located, based on the statistical prediction model applied on the acquired first set of information, as shown at step 46;
acquisition, by the acquisition module 35 of the second set of information at least from the second marking unit 24, the third marking unit 26 and the second imaging module 32, as shown at step 47; and
estimation, for each secondary packaging unit 10, of the marking of the specific tertiary packaging unit 14 in which the same secondary packaging unit 10 is located, based on the statistical prediction model applied on the acquired second set of information, as shown at step 48.

As previously discussed, steps 45 and 47 may also envisage acquisition of the operating data from the operating sensors 40; and steps 46, 48 may envisage estimation to be carried out based also on the acquired operating data (in this case, the statistical prediction model being applied also on the same operating data).

The estimated tracking information may allow to perform suitable operations on the packaging line 4 of the packaging plant 1, as shown at step 49, with reference to specific primary, secondary and/or tertiary packaging units 6, 10, 14, which are considered of particular relevance.

For example, secondary or tertiary packaging units 10, 14, which are estimated to comprise possibly contaminated or not sterile primary packaging units 6, may be more closely monitored or collected for their disposal or further analysis. As previously discussed, the possibly contaminated or not sterile primary packaging units 6 may be those that have been produced sequentially to (or temporally near) other primary packaging units 6 that have been tested to be contaminated (or to have any other kinds of defects).

In a possible embodiment, the control unit 34 may also be coupled (via any suitable wireless communication link) to mobile terminals (e.g., smartphones, phablets, tablets or similar, running a suitable software application or “app”) carried by operators of the packaging plant 1; the mobile terminals, provided with display and interface modules, may display the above discussed tracking information (including e.g., the position of the specific packaging units) and possibly the suggested actions to be performed on the packaging line 4.

It is underlined that the above discussed operations may be performed in real-time or quasi real-time by the control unit 34, while packaging operations are carried out in the packaging plant 1; alternatively, or in addition, the collected data may be stored for subsequent processing (e.g., for statistical analyses).

The advantages the present solution allows to achieve are clear from the foregoing description.

In any case, it is underlined that the automated tracking system 20 allows to improve tracking of packaging units produced in the packaging plant 1, in particular in order to locate specific primary packaging units 6 packaged in respective secondary packaging units 10; and/or to locate specific secondary packaging units 10 packaged in respective tertiary packaging units 14.

Advantageously, the proposed solution envisages use of a limited number of marking units 22 in the packaging line 4, for detection of packaging markings, as compared to known solutions; in particular, only the first, second and third marking units 222, 24, 26 are envisaged, respectively at the primary, respectively secondary and tertiary packaging machines 5, 9, 13.

Finally, it is clear that modifications and variations may be made to what has been described and illustrated herein, without thereby departing from the scope of the present invention, as defined in the appended claims.

For example, the processing machines 2, in particular the primary, secondary and/or tertiary packaging machines 5, 9, 13 may include positive (active) transporting units, e.g., rotary conveyors, such as rotating discs or star-wheels, configured for transporting the packaging units (or part thereof) internally to the same processing machines 2.

Primary packaging machine 5 can comprise a first positive transporting unit for transporting containers. The first marking unit 22 operates to mark each primary packaging unit 6 while the respective container is being transported by the first transporting unit.

Secondary packaging machine 9 can comprise a second positive transporting unit for transporting secondary packaging units 10. The second marking unit 24 can operate to mark each secondary packaging unit 10 while the respective secondary packaging unit 10 is being transported by the second transporting unit.

Tertiary packaging machine 13 can comprise a third positive transporting unit for transporting tertiary packaging units 14. The third marking unit 26 can operate to mark each tertiary packaging unit 14 while the respective tertiary packaging unit 14 is being transported by the third transporting unit.

“Positive transporting unit” means a unit configured for transporting any packaging unit in a totally active, positive and ordered manner. For example, a starwheel or any other conveyor configured for tranporting packaging units or containers in a completely ordered manner can be considered a positive transporting unit.

Each conveying unit 8 or 11 is at least partially or totally passive and/or at least partially or totally of the accumulator type.

In this way, by means of the statistical approach the control unit 35 can leverage the positive nature of the transporting units for compensating the passive nature of the conveying units 8 and 11, to assign each primary marking to a respective secondary marking, and/or to assign each secondary marking to a tertiary marking. Therefore, the estimations can be more accurate.

The tracking system can comprise an interface for informing a user about the results of the estimations.

Moreover, it is underlined that the disclosed automated tracking system 20 may be advantageously applied irrespective of the type of packaging plant 1, the type of processing machines 2 or the type of packaging units and products being processed.

In particular, the present solution may be implemented in plants for processing any type of primary packaging units, such as bottles or other kinds of containers or receptacles made of glass, plastic (PET), aluminium, steel and composite materials, that are to be filled with any pourable product, in particular a food product, including sparkling liquids, such as sparkling water, non-alcoholic beverages and beer; non-effervescent liquids, such as natural water, milk, juices, tea, integrators for sport activities or wine.

1. An automated tracking system for a packaging plant for packaging a pourable product, the packaging plant comprising:
a primary packaging machine, configured to produce sequentially a plurality of primary packaging units, each primary packaging unit comprising at least one respective container;
a secondary packaging machine, configured to produce sequentially a plurality of secondary packaging units, each secondary packaging unit including a group of at least two primary packaging units;
a first conveying unit, configured to transport the primary packaging units received from the primary packaging machine, from the primary packaging machine to the secondary packaging machine,
the automated tracking system comprising:
a first marking unit configured to assign to each primary packaging unit a respective primary marking;
a second marking unit configured to assign to each secondary packaging unit a respective secondary marking; and
a first imaging module, configured to image said first conveying unit; and
a control unit;
wherein said control unit comprises:
an acquisition module configured to acquire a first set of information at least from said first marking unit, said first imaging module, and said second marking unit; and
a prediction module configured to perform an estimation, for each primary packaging unit, of the marking of a specific secondary packaging unit in which said primary packaging unit is packaged, based on a statistical prediction model applied on the acquired first set of information.

2. The system according to claim 1, wherein:
the primary packaging machine comprises a first positive transporting unit for transporting containers, the first marking unit being configured to mark each primary packaging unit while the respective container is being transported by the first transporting unit; and
the first conveying unit is passive.

3. The system according to claim 2, wherein the secondary packaging machine comprises a second positive transporting unit for transporting secondary packaging units, the second marking unit being configured to mark each secondary packaging unit while the respective secondary packaging unit is being transported by the second transporting unit.

4. The system according to claim 1, wherein the packaging plant comprises:
a tertiary packaging machine, configured to produce sequentially a plurality of tertiary packaging units, each tertiary packaging unit including a group of at least two secondary packaging units; and
a second conveying unit, configured to transport the secondary packaging units received from the secondary packaging machine, from the secondary packaging machine to the tertiary packaging machine,
the automated tracking system further comprising:
a third marking unit configured to assign to each tertiary packaging unit a respective tertiary marking; and
a second imaging module, configured to image said second conveying unit,
the acquisition module being further configured to acquire a second set of information at least from said second marking unit, said second imaging module and said third marking unit; and
the prediction module being further configured to perform an estimation, for each secondary packaging unit, of the marking of a specific tertiary packaging unit in which said secondary packaging unit is packaged, based on a statistical prediction model applied on the acquired second set of information.

5. The system according to claim 4, wherein the second conveying unit is passive of an accumulator type or both.

6. The system according to claim 5, wherein the tertiary packaging machine comprises a third positive transporting unit for transporting tertiary packaging units, the third marking unit being configured to mark each tertiary packaging unit while the respective tertiary packaging unit is being transported by the third transporting unit.

7. The system according to claim 1, further comprising:
a plurality of monitoring sensors configured to be arranged at the packaging plant and configured to provide operating data related to packaging operations performed in said packaging plant,
wherein the acquisition module is further configured to acquire the operating data provided by the monitoring sensors and the prediction module is configured to process each set of information and the acquired operating data to perform said estimation.

8. The system according to claim 7, wherein the monitoring sensors comprise speed sensors, position sensors, presence detectors, motion detectors, or combinations thereof.

9. The system according to claim 1, wherein each imaging module of the system comprises a camera or an image sensor.

10. The system according to claim 1, wherein said statistical prediction model is based on a Discrete Element Method (DEM).

11. A packaging plant, comprising the automated tracking system according to claim 1.

12. A machine-implemented tracking method for a packaging plant for packaging a pourable product, the packaging plant comprising:
a primary packaging machine, configured to produce sequentially a plurality of primary packaging units, each primary packaging unit comprising at least a respective container;
a secondary packaging machine, configured to produce sequentially a plurality of secondary packaging units, each secondary packaging unit including a group of at least two primary packaging units; and
a first conveying unit, configured to transport the primary packaging units received from the primary packaging machine, from the primary packaging machine to the secondary packaging machine,
the method comprising:
marking each primary packaging unit with a respective primary marking;
marking each secondary packaging unit with a respective secondary marking;
imaging said first conveying unit with a first imaging module;
acquiring a first set of information at least from said first marking unit, said first imaging module, and said second marking unit; and
processing the acquired first set of information in order to perform an estimation, for each primary packaging unit, of the marking of a specific secondary packaging unit in which said primary packaging unit is packaged, based on a statistical prediction model applied on the acquired first set of information.

13. The method according to claim 12, wherein the packaging plant further comprises:
a tertiary packaging machine, configured to produce sequentially a plurality of tertiary packaging units, each tertiary packaging unit including a group of at least two secondary packaging units; and
a second conveying unit, configured to transport the secondary packaging units received from the secondary packaging machine, from the secondary packaging machine to the tertiary packaging machine;
the method further comprising:
marking each tertiary packaging unit with a respective tertiary marking via a third marking unit;
imaging said second conveying unit with a second imaging module;
acquiring a second set of information at least from said second marking unit, said second imaging module and said third marking unit; and
processing the acquired second set of information in order to perform an estimation, for each secondary packaging unit, of the marking of a specific tertiary packaging unit in which said secondary packaging unit is packaged, based on a statistical prediction model applied on the acquired second set of information.

14. The method according to claim 12, further comprising:
acquiring operating data related to packaging operations performed in the packaging plant from a number of monitoring sensors arranged at the packaging plant; and
processing each set of information and the acquired operating data to perform said estimation.

15. The method according to claim 14, wherein the monitoring sensors comprise speed sensors and/or position sensors and/or presence detectors and/or motion detectors.

16. The method according to claim 12, wherein said statistical prediction model is based on a Discrete Element Method (DEM).
